(19) United States
(12) Patent Application Publication
(10) Pub. No.: US 2006/0260903 A1
(43) Pub. Date: Nov. 23, 2006

(54) CLAMPING PLATE

(75) Inventors: Hiroshi Kaneda, Tokyo (JP); Masaru Ikebe, Tokyo (JP); Kenji Hashizume, Tokyo (JP)

Correspondence Address: GREENBLUM & BERNSTEIN, P.L.C., 1950 ROLAND CLARKE PLACE, RESTON, VA, 20191, US

(73) Assignee: TDK CORPORATION, Tokyo (JP)

(21) Appl. No.: 11/419,315

(22) Filed: May 19, 2006

(30) Foreign Application Priority Data
May 20, 2005 (JP) 2005-147450

(51) Int. Cl. F16D 19/00

(52) U.S. Cl. 192/100

(57) ABSTRACT

A clamping plate includes a circular-plate-shaped main plate and a cylindrical outer wall formed by bending an outer edge portion of the main plate. The clamping plate moves due to being pulled by magnetic attraction by a disc rotating mechanism to clamp a disk-shaped recording medium to the disc rotating mechanism. At least one of a convex that protrudes outward in a radial direction of the main plate and a concave that is depressed inward in the radial direction is formed in the outer wall.

### BACKGROUND OF THE INVENTION

1. Field of the Invention

The present invention relates to a clamping plate that is pulled by suction by a disc rotating mechanism of a recording/reproducing apparatus or the like so as to move and clamp a disk-shaped recording medium to the disc rotating mechanism.

2. Description of the Related Art

A disc cartridge equipped with this type of clamping plate is disclosed by Japanese Laid-Open Patent Publication No. 2003-91955. This disc cartridge is constructed by enclosing a disk-shaped recording medium and an inner rotor and the like inside a cartridge case (composed of a lower shell and an upper shell). With this disc cartridge, a clamping plate for clamping the disk-shaped recording medium to a disc rotating mechanism (turntable) of a recording/reproducing apparatus is rotatably attached to an inner surface of the upper shell by a ring-shaped clamping plate retainer (hereinafter, simply “retainer”). The clamping plate is integrally formed by pressing a magnetic metal plate so as to include a circular (circular plate shaped) base surface portion, a conical (or cylindrical) side wall portion, and an annular brim portion for attachment to the upper shell via the retainer. With this disc cartridge, the clamping plate moves due to magnetic attraction by the disc rotating mechanism so that the base surface portion thereof contacts a rim portion of a center hole of the disk-shaped recording medium and presses the disk-shaped recording medium toward the disc rotating mechanism. By doing so, the disk-shaped recording medium is clamped to the disc rotating mechanism.

However, by investigating the conventional clamping plate described above, the present inventors discovered the following problem. Since the side wall portion of the clamping plate described above tapers (i.e., is formed in a conical shape), the external diameter of the base surface portion-end of the side wall portion is smaller than the internal diameter of the brim portion-end of the side wall portion. Accordingly, during the manufacturing of disc cartridges, when a large number of clamping plates are stored as assembly components in a component storage box or the like, as shown in FIG. 9, a plurality of clamping plates become jammed together with the outer surface of the side wall portion of one clamping plate in surface contact with the inner surface of the side wall portion of another clamping plate. Since oils such as mold lubricant and detergent oil adhere to such clamping plates which are formed by a pressing process, when the clamping plates engage one another as shown in FIG. 9, the contacting parts of the clamping plates become tightly jammed together, making it more difficult to separate the individual clamping plates. For this reason, with the conventional clamping plate described above, there is the problem that an extremely complex process is required to separate the plurality of jammed-together clamping plates into individual plates when the clamping plates are ground (to remove burrs) after pressing or attached to upper shells.

### SUMMARY OF THE INVENTION

The present invention was conceived in view of the problem described above and it is a principal object of the present invention to provide a clamping plate that makes it possible to store a plurality of clamping plates in a component storage box or the like without the clamping plates becoming jammed together.

To achieve the stated object, a clamping plate according to the present invention includes: a circular-plate-shaped main plate; and a cylindrical outer wall formed by bending an outer edge portion of the main plate, wherein the clamping plate moves due to being pulled by magnetic attraction by a disc rotating mechanism to clamp a disk-shaped recording medium to the disc rotating mechanism, and at least one of a convex that protrudes outward in a radial direction of the main plate and a concave that is depressed inward in the radial direction is formed in the outer wall. Note that the expression “circular-plate-shaped main plate” for the present specification includes a plate that has a circular concave, a round hole, or the like formed in a center part thereof

According to the clamping plate described above, by forming at least one of a convex that protrudes outward in a radial direction of the main plate and a concave that is depressed inward in the radial direction in the outer wall, when a convex is formed in the outer wall, even if the main plate of a given clamping plate is inserted inside the outer wall of another clamping plate (on the rear of the main plate) so as to jam the clamping plates together, an upper surface of the convex of the given clamping-plate will contact one end of the outer wall of the other clamping plate (“an outer end in the direction of insertion”, here an opposite end of the outer wall to the main plate), thereby preventing insertion. Similarly, when a concave is formed in the outer wall, even if the main plate of a given clamping plate is inserted inside the outer wall of another clamping plate (from the rear of the main plate) so as to jam the clamping plates together, one end of the outer wall of the given clamping plate (“an inner end in the direction of insertion”, here the main plate-end of the outer wall) will contact a rear surface of a base surface of the concave of the other clamping plate, thereby preventing insertion. This means that by forming at least one of a convex and a concave on the outer wall, even if a large number of clamping plates are stored as assembly components in a component storage box or the like, it is possible to keep the clamping plates apart without the clamping plates becoming jammed together. Accordingly, a complex separating operation is unnecessary and grinding or attachment to a cartridge case or disk-shaped recording medium can start immediately for the clamping plates. As a result, it is possible to reduce the manufacturing cost of a disc cartridge (information recording medium).

Here, the clamping plate may be formed so that the outer wall is formed in a taper so that the diameter thereof increases as the distance from the main plate increases, and the convex is formed so that a protruding end part thereof protrudes further outward than a largest diameter part of the outer wall. With this construction, the convex will reliably contact the largest diameter part of the outer wall, and therefore it is possible to reliably keep respective clamping plates apart.

Another clamping plate according to the present invention includes: a circular-plate-shaped main plate; and a cylindrical outer wall formed by bending an outer edge portion of the main plate, wherein a circular concave that is depressed in a direction in which the outer wall is bent is formed in a central portion of the main plate and the clamping plate moves due to being pulled by magnetic attraction by a disc rotating mechanism to clamp a disk-shaped recording medium to the disc rotating mechanism, wherein at least one of a concave that is depressed outward in a radial direction of the main plate and a convex that protrudes inward in the radial direction is formed in an inner wall of the circular concave.

According to the clamping plate described above, by forming at least one of a convex that protrudes inward in a radial direction of the main plate and a concave that is depressed outward in the radial direction in the inner wall, when a convex is formed in the inner wall, even if the main plate of a given clamping plate is inserted inside the outer wall of another clamping plate (on the rear of the main plate) so as to jam the clamping plates together, an upper surface of the convex of the given clamping plate will contact one end of the inner wall of the other clamping plate (“an outer end in the direction of insertion”, here a circular concave base portion-end of the inner wall), thereby preventing insertion. Similarly, when a concave is formed in the inner wall, even if the main plate of a given clamping plate is inserted inside the outer wall of another clamping plate (from the rear of the main plate) so as to jam the clamping plates together, one end of the inner wall of the given clamping plate (“an inner end in the direction of insertion”, here the main plate-end of the inner wall) will contact a rear surface of a base surface of the concave of the other clamping plate, thereby preventing insertion. This means that even if a large number of clamping plates are stored as assembly components in a component storage box or the like, it is possible to keep the clamping plates apart without the clamping plates becoming jammed together. Accordingly, a complex separating operation is unnecessary and grinding or attachment to a cartridge case or disk-shaped recording medium can start immediately for the clamping plates. As a result, it is possible to reduce the manufacturing cost of a disc cartridge (information recording medium).

Here, the clamping plate may be formed so that the inner wall is formed in a taper so that the diameter thereof decreases as the distance from the main plate increases, and the convex is formed so that a protruding end part thereof protrudes further inward than a smallest diameter part of the inner wall. With this construction, the convex will reliably contact the smallest diameter part of the inner wall, and therefore it is possible to reliably keep respective clamping plates apart.

It should be noted that the disclosure of the present invention relates to a content of Japanese Patent Application 2005-147450 that was filed on 20 May 2005 and the entire content of which is herein incorporated by reference.

### BRIEF DESCRIPTION OF THE DRAWINGS

These and other objects and features of the present invention will be explained in more detail below with reference to the attached drawings, wherein:

FIG. 1 is an external perspective view of a disc cartridge;

FIG. 2 is a cross-sectional view, taken along a line A-A in FIG. 1;

FIG. 3 is a plan view of a clamping plate;

FIG. 4 is an external perspective view showing the periphery of a convex on the clamping plate shown in FIG. 3;

FIG. 5 is a cross-sectional view of a state where a plurality of the clamping plates shown in FIG. 3 are stacked;

FIG. 6 is a plan view of another clamping plate;

FIG. 7 is an external perspective view showing the periphery of a concave on the clamping plate shown in FIG. 6;

FIG. 8 is a cross-sectional view of a state where a plurality of the clamping plates shown in FIG. 6 are stacked; and

FIG. 9 is a cross-sectional view of a state where a plurality of conventional clamping plates are jammed together.

### DESCRIPTION OF THE PREFERRED EMBODIMENTS

Preferred embodiments of a clamping plate according to the present invention will now be described with reference to the attached drawings.

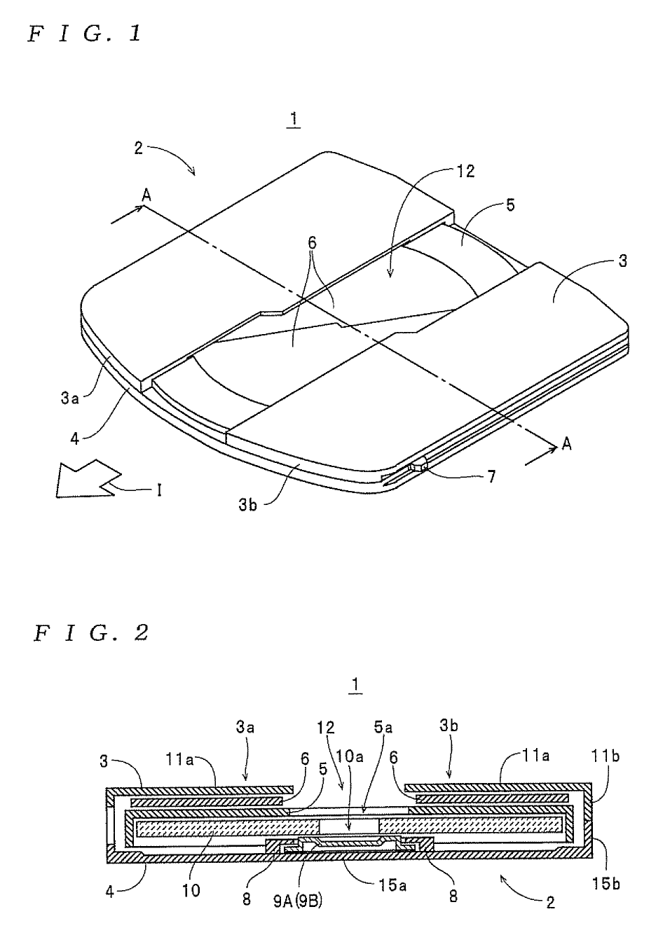

A disc cartridge 1 shown in FIGS. 1 and 2 is a cartridge-type information recording medium constructed so that the recording and reproducing of various types of recording data are possible, and includes parts such as an inner rotor 5, a shutter member 6, a locking member 7, a clamping plate 9A, and an optical disc 10 enclosed inside a cartridge main body 2. It should be noted that in FIG. 2, sizes in the thickness direction have been exaggerated for ease of understanding the present invention. Here, as one example, the optical disc 10 is a single-sided rewritable disk-shaped recording medium and as shown in FIG. 2, a center hole 10a with a diameter of around 15 mm is formed in a center part thereof for clamping (clamping) in a recording/reproducing apparatus. As described later, the optical disc 10 is clamped to a disc rotating mechanism (not shown) in the recording/reproducing apparatus by having the disc rotating mechanism magnetically pull the clamping plate 9A attached to the cartridge main body 2 toward a lower shell 3 (i.e., by moving the clamping plate 9A by magnetic attraction).

On the other hand, as shown in FIGS. 1 and 2, the cartridge main body 2 includes the lower shell 3 and an upper shell 4 that are injection molded from a resin material so as to be capable of fitting together (i.e., capable of being placed on top of one another). The lower shell 3 includes a pair of lower shell main parts 3a, 3b. More specifically, as shown in FIG. 2, the lower shell 3 (i.e., the lower shell main parts 3a, 3b) includes base plates 11a, side plates 11b that are erected on outer edges of the base plates 11a and construct side surface parts of the cartridge main body 2, and partition walls (not shown) that form a disc enclosure inside the cartridge main body 2. The lower shell 3 is constructed so that in a state where the lower shell 3 is fitted together with the upper shell 4 (i.e., in a state where the lower shell 3 has been integrated with the upper shell 4), a disc-access opening (hereinafter, simply “opening”) 12 is formed between the respective base plates 11a of the lower shell main parts 3a, 3b. The size, shape, and position of the opening 12 are set so that disc access (i.e., clamping by the recording/reproducing apparatus, irradiation with a laser beam using an optical head, and the like) is possible for the optical disc 10 inside the cartridge main body 2 during the recording and reproducing of recording data, and as one example, the opening is formed so as to extend from one outer edge of the lower shell 3 across the center part to the other outer edge on the opposite side. The upper shell 4 includes a top plate 15a, side walls 15b that are erected at outer edges of the top plate 15a and together with the side walls 11b of the lower shell 3 construct the side wall parts of the cartridge main body 2, and partition walls (not shown) that together with the partition walls of the lower shell 3 form the disc enclosure inside the cartridge main body 2. The clamping plate 9A is attached to a center part of the upper shell 4 by an attaching member 8.

As shown in FIG. 2, the inner rotor 5 includes a circular-plate-shaped base plate in which an opening 5a is formed with substantially the same width as the opening 12 formed between the lower shell main parts 3a, 3b of the lower shell 3 and a side wall that is erected at an outer edge of the base plate, and therefore is formed as a shallow plate on which the optical disc 10 can be mounted. As shown in FIG. 2, the inner rotor 5 is enclosed so as to be rotatable inside the cartridge main body 2 together with the optical disc 10. Engaging teeth (not shown) that can engage a shutter opening/closing means (not shown) of the recording/reproducing apparatus are also formed in the side wall of the inner rotor 5. In addition, in a state where the disc cartridge 1 has been ejected from the recording/reproducing apparatus, rotation of the inner rotor 5 with respect to the cartridge main body 2 is restricted by the locking member 7 (see FIG. 1). First ends of the shutter members 6 are axially supported by the inner rotor 5, and slits (not shown) through which the convexes of the lower shell 3 can be inserted are formed at other ends of the respective shutter members 6 that are enclosed inside the cartridge main body 2 so as to be sandwiched between the lower shell 3 and the inner rotor 5. By rotating the inner rotor 5 with respect to the cartridge main body 2, the shutter members 6 are caused to rotate with respect to the inner rotor 5 and therefore to slide between a closed position where the shutter members 6 cover the opening 12 and an open position where the opening 12 is open. The attaching member 8 is formed in a ring-shape by injection molding a resin material, and as shown in FIG. 2, rotatably attaches the clamping plate 9A to the upper shell 4. The clamping plate 9A is attached via the attaching member 8 so as to be capable of slight movement toward and away from the top plate 15a of the upper shell 4.

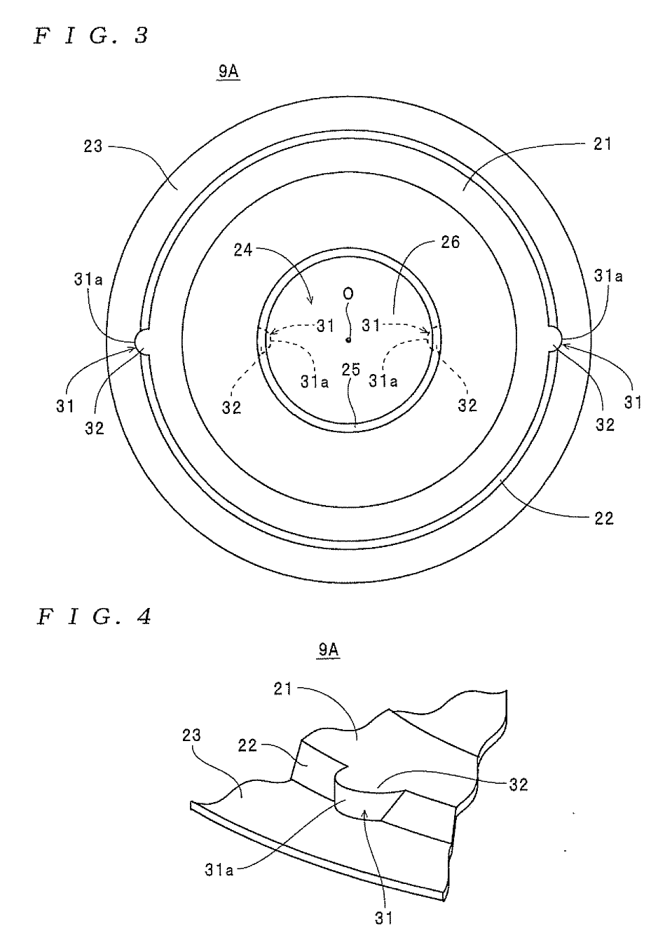

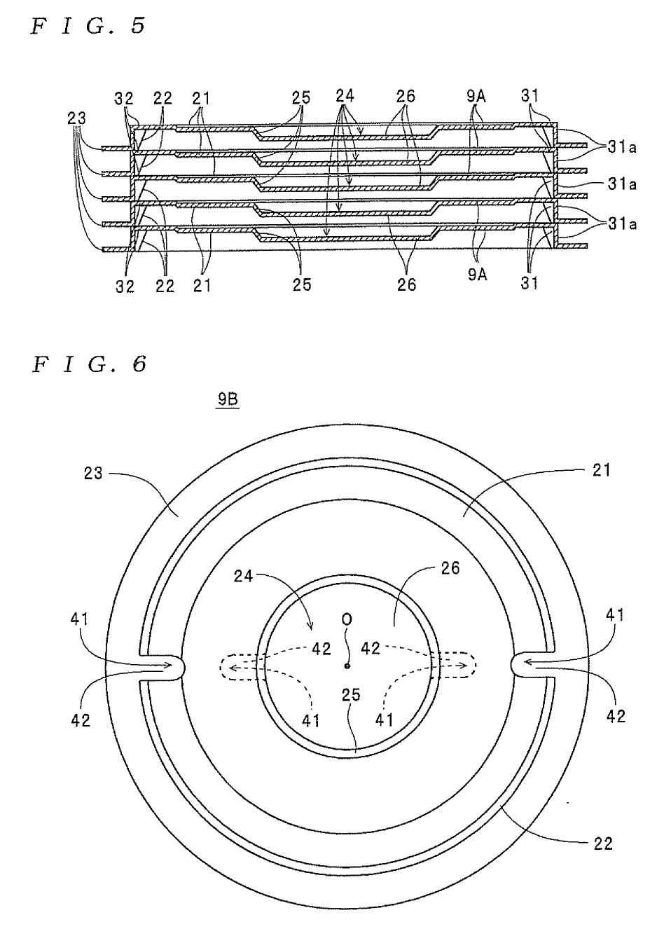

The clamping plate 9A is formed by pressing a magnetic metal plate (as one example, stainless steel plate with a thickness of around 0.3 mm), and as shown in FIGS. 3 to 5, is formed in an overall shape of a brimmed hat. More specifically, the clamping plate 9A is integrally formed with a circular-plate-shaped main plate 21, a cylindrical outer wall 22 formed by bending an outer edge portion of the main plate 21, and a brim portion 23 for attaching the clamping plate 9A to the upper shell 4 via the attaching member B. As shown in FIG. 5, the outer wall 22 is formed in a taper so that the diameter of the outer wall 22 increases as the distance from the main plate 21 increases. Also, as shown in FIGS. 3 to 5, convexes 31 that protrude outward in the radial direction of the main plate 21 are formed on the outer wall 22. In the illustrated example, two convexes 31 are formed on the outer wall 22 of the clamping plate 9A on opposite sides of the center O (see FIG. 3) of the main plate 21. Also, protruding end portions 31a of the convexes 31 that protrude outward in the radial direction of the main plate 21 are formed so as to protrude further outward than the largest diameter part of the outer wall 22 (i.e., the brim portion 23-end of the outer wall 22). On the clamping plate 9A, upper surfaces 32 of the convexes 31 (end surfaces of the convexes 31 that protrude outward in the radial direction of the main plate 21) are formed so as to be flush with an outer circumferential portion of the main plate 21. On the other hand, a circular concave 24 is formed in a central portion of the main plate 21 to prevent a rotational shaft of the disc rotating mechanism from contacting the clamping plate 9A. Here, an inner wall 25 of the circular concave 24 is formed in a taper so that the diameter of the inner wall 25 decreases as the distance from the main plate 21 increases (i.e., the diameter of the inner wall 25 decreases toward a base portion 26 of the circular concave 24).

With the clamping plate 9A used in the disc cartridge 1, during the manufacturing of the disc cartridge 1, when a large number of the clamping plates 9A are stored as assembly components in a component storage box (not shown), for example, it is possible to keep the individual clamping plates 9A apart without the clamping plates 9A becoming jammed together. More specifically, even if the main plate 21 of a given clamping plate 9A is inserted inside the outer wall 22 of another clamping plate 9A from the rear of the other clamping plate 9A (inside the brim portion 23: on the rear of the main plate 21), as shown in FIG. 5, the upper surfaces 32 of the convexes 31 of the given clamping plate 9A will contact an end of the outer wall 22 of the other clamping plate 9A (this end being one example of “a largest diameter part”, here the brim portion 23-end of the outer wall 22), thereby preventing insertion of the main plate 21 inside the outer wall 22. As a result, unlike the conventional clamping plate, the clamping plates 9A are prevented from becoming jammed together inside the storage box. Accordingly, a complex operation to separate the clamping plates is not required and the clamping plates can be immediately subjected to a grinding process (deburring) or attachment to the upper shell.

On the other hand, with a fully assembled disc cartridge 1, as shown in FIG. 1, when the disc cartridge 1 has been ejected from the recording/reproducing apparatus, the opening 12 of the lower shell 3 is covered by the inner rotor 5 and the shutter members 6. Also, when the disc cartridge 1 has been loaded into the recording/reproducing apparatus, the disc cartridge 1 is pulled by the recording/reproducing apparatus inside the apparatus in the direction of the arrow I. Note that although a state where the lower shell 3 faces upward is shown in FIG. 1, during actual use, the disc cartridge 1 is loaded into the recording/reproducing apparatus in a state where the upper shell 4 faces upward. When doing so, the inner rotor 5 is rotated by a shutter opening/closing means of the recording/reproducing apparatus and as a result, the shutter members 6 are caused to rotate relative to the inner rotor 5 to open the opening 12. By doing so, the optical disc 10 becomes exposed and it becomes possible to carry out disc access to the optical disc 10 from outside the cartridge main body 2. Next, the clamping plate 9A is magnetically pulled by the disc rotating mechanism (not shown) of the recording/reproducing apparatus, thereby clamping the rim portion (a center region) of the center hole 10a. More specifically, the main plate 21 of the clamping plate 9A contacts the rim portion of the center hole 10a of the optical disc 10 to press the optical disc 10 toward the disc rotating mechanism, thereby clamping the optical disc 10. Next, the disc rotating mechanism rotates the optical disc 10 at a predetermined rotational speed. When doing so, the convexes 31 are formed at positions on opposite sides of the center O of the clamping plate 9A that rotates together with the optical disc 10. Accordingly, a situation where the rotation of the clamping plate 9A becomes unbalanced due to the convexes 31 being formed (a situation where the weight is no longer centered on the center O) is avoided. After this, irradiation with a laser beam is carried out via the opening 12 (i.e., the recording or reproducing of recording data) is carried out.

In this way, according to the clamping plate 9A, since the convexes 31 that protrude outward in the radial direction of the main plate 21 are formed on the outer wall 22, even if the main plate 21 of a given clamping plate 9A is inserted inside the outer wail 22 (on the rear of the main plate 21) of another clamping plate 9A so as to jam the clamping plates 9A together, the upper surfaces 32 of the convexes 31 of the given clamping plate 9A will contact one end of the outer wall 22 of the other clamping plate 9A (i.e., an “outer end in the direction of insertion”, here the brim portion 23-end of the outer wall 22), thereby preventing insertion. This means that even if a large number of clamping plates 9A are stored as assembly components in a component storage box, it is possible to keep the clamping plates 9A apart without the clamping plates 9A becoming jammed together. Accordingly, a complex separating operation is unnecessary and grinding or attachment to the upper shell can start immediately for the clamping plates 9A. As a result, it is possible to reduce the manufacturing cost of the disc cartridge 1.

Also, according to the clamping plate 9A, by having the protruding end portions 31a of the convexes 31 protrude further outward than the largest diameter part of the outer wall 22 (the brim portion 23-end of the outer wall 22), it is possible to have the convexes 31 reliably contact the largest diameter part of the outer wall 22, and therefore a state where the clamping plates 9A are kept apart can be reliably maintained.

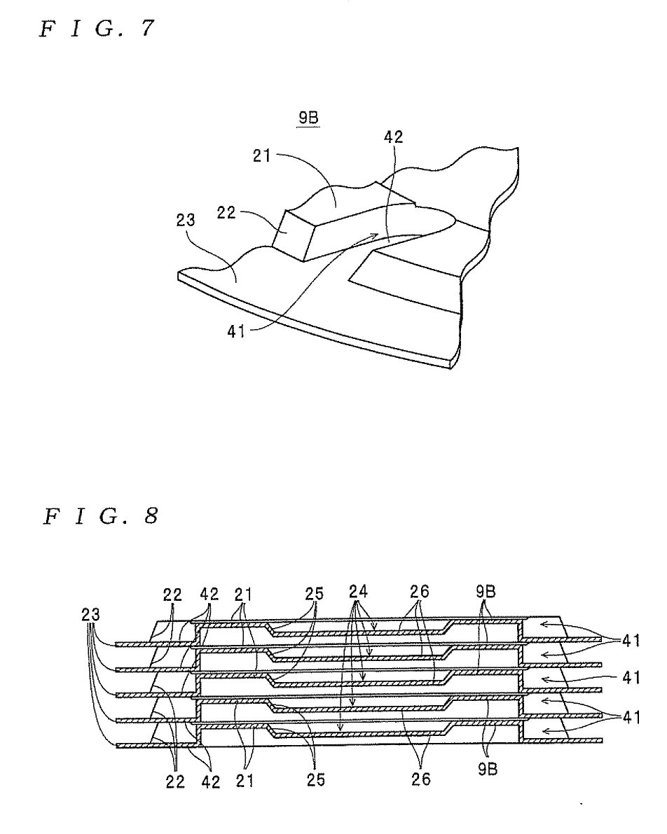

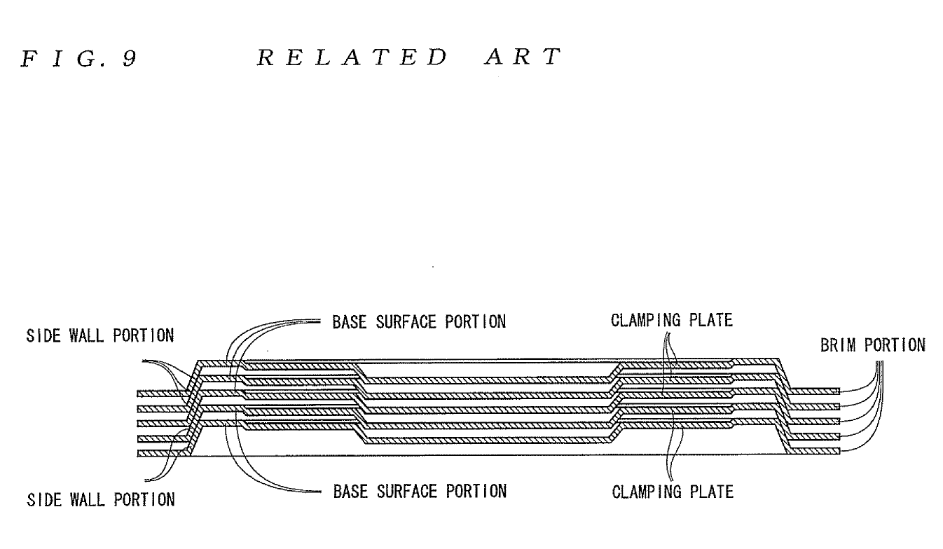

Note that the present invention is not limited to the construction described above. For example, with the clamping plate 9A described above, although the convexes 31 that protrude outward in the radial direction of the main plate 21 are formed on the outer wall 22, in the same way as a clamping plate 9B shown in FIGS. 6 to 8, in place of the convexes 31, it is possible to form concaves 41 that are depressed inward in the radial direction of the main plate 21 in the outer wall 22. Note that component elements that are the same as the clamping plate 9A described above have been assigned the same reference numerals and duplicated description thereof has been omitted. On the clamping plate 9B, two concaves 41 are formed in the outer wall 22 on opposite sides of the center 0 (see FIG. 6) of the main plate 21. Also, on the clamping plate 9B, base surfaces 42 of the concaves 41 (i.e., the end surfaces of the concaves 41 that are depressed inward in the radial direction of the main plate 21) are formed flush with the brim portion 23.

Like the clamping plate 9A described above, with the clamping plate 9B, when a large number of clamping plates 9B are stored as assembly components in a component storage box (not shown), for example, the individual clamping plates 9B are kept apart without becoming jammed together. More specifically, even if the main plate 21 of a given clamping plate 9B is inserted inside the outer wall 22 of another clamping plate 9B from the rear side of the other clamping plate 9B (inside the brim portion 23: on the rear of the main plate 21) so as to jam the clamping plates together, as shown in FIG. 8, the rear surfaces of the base surfaces 42 of the concaves 41 of the other clamping plate 9B contact one end of the outer wall 22 of the given clamping plate 9B (in this example, the main plate 21-end), thereby preventing insertion of the main plate 21 inside the outer wall 22. As a result, like the clamping plate 9A described above, the clamping plates 9B are prevented from becoming jammed together inside the storage box.

In this way, according to the clamping plate 9B, since the concaves 41 that are depressed inward in the radial direction of the main plate 21 are formed on the outer wall 22, even if the main plate 21 of a given clamping plate 9B is inserted inside the outer wall 22 (on the rear of the main plate 21) of another clamping plate 9B so as to jam the clamping plates 9B together, the rear surfaces of the base surfaces 42 of the concaves 41 of the other clamping plate 9B will contact one end of the outer wall 22 of the given clamping plate 9B (an “inner end in the direction of insertion”, here the main plate 21-end of the outer wall 22), thereby preventing insertion. This means that even if a large number of clamping plates 9B are stored as assembly components in a component storage box, it is possible to keep the clamping plates 9B apart without the clamping plates 9B becoming jammed together. Accordingly, a complex separating operation is unnecessary and grinding or attachment to the upper shell can start immediately for the clamping plates 9B. As a result, it is possible to reduce the manufacturing cost of the disc cartridge 1.

Also, although the convexes 31 that protrude outward in the radial direction of the main plate 21 are formed on the outer wall 22 of the clamping plate 9A described above, the present invention is not limited to this and as shown by the broken lines in FIG. 3, convexes 31 that protrude inward in the radial direction of the main plate 21 may be formed on the inner wall 25. In this case, the protruding end portions 31a of the convexes 31 should preferably protrude further inward than the smallest diameter-part of the inner wall 25 (i.e., the base portion 26-end of the inner wall 25) of the circular concave 24. With a clamping plate where the convexes 31 are formed on the inner wall 25, like the clamping plate 9A described above, even if the main plate 21 of a given clamping plate is inserted inside the outer wall 22 (on the rear of the main plate 21) of another clamping plate so as to jam the clamping plates together, the upper surfaces 32 of the convexes 31 of the given clamping plate will contact one end of the inner wall 25 of the other clamping plate (i.e., the “outer end in the direction of insertion”, here the base portion 26-end of the inner wall 25), thereby preventing insertion. This means that even if a large number of clamping plates are stored as assembly components in a component storage box, it is possible to keep the clamping plates apart without the clamping plates becoming jammed together. Accordingly, a complex separating operation is unnecessary and grinding or attachment to the upper shell can start immediately for the clamping plates. As a result, it is possible to reduce the manufacturing cost of the disc cartridge 1.

Also, although the concaves 41 that are depressed inward in the radial direction of the main plate 21 are formed on the outer wall 22 of the clamping plate 9B described above, the present invention is not limited to this and as shown by the broken lines in FIG. 6, concaves 41 that are depressed outward in the radial direction of the main plate 21 may be formed on the inner wall 25. With a clamping plate where the concaves 41 are formed on the inner wall 25, like the clamping plate 9B described above, even if the main plate 21 of a given clamping plate is inserted inside the outer wall 22 (on the rear of the main plate 21) of another clamping plate so as to jam the clamping plates together, rear surfaces of the base surfaces 42 of the concaves 41 of the other clamping plate will contact one end of the inner wall 25 of the given clamping plate (i.e., the “inner end in the direction of insertion”, here the main plate 21-end of the inner wall 25), thereby preventing insertion. This means that even if a large number of clamping plates are stored as assembly components in a component storage box, it is possible to keep the clamping plates apart without the clamping plates becoming jammed together. Accordingly, a complex separating operation is unnecessary and grinding or attachment to the upper shell can start immediately for the clamping plates. As a result, it is possible to reduce the manufacturing cost of the disc cartridge 1.

Also, although only two convexes 31 or two concaves 41 are formed on both sides of the center O of the clamping plates 9A, 9B described above, the number of formed convexes 31 and concaves 41 is not limited to this. In addition, both the convexes 31 and the concaves 41 may be formed on a single clamping plate. In addition, although the clamping plates 9A, 9B that are constructed as separate components to the optical disc 10 have been described as examples, the clamping plate according to the present invention includes a clamping plate that is integrated with the optical disc 10. The brim portion 23 for attachment to the upper shell 4 via the attaching member 8 is not an essential part of the clamping plate according to the present invention, and at least one of the convexes 31 and the concaves 41 can be formed on a clamping plate that does not include a brim portion 23. Similarly, the circular concave 24 of the clamping plates 9A, 9B described above is not an essential part of the clamping plate according to the present invention, and a clamping plate in which a round hole is formed in place of the circular concave 24 and a clamping plate where the main plate 21 is constructed of a circular plate without a circular concave 24 or a round hole are included in the present invention.

In addition, the disk-shaped recording medium for the present invention is not limited to the rewritable optical disc 10 described above, and includes various kinds of optical discs such as read-only optical discs and write-once optical discs, as well as magneto-optical discs, magnetic discs, and the like. Also, although the cartridge main body 2 of the disc cartridge 1 described above is constructed of the lower shell 3 including the separate lower shell main parts 3a, 3b, the cartridge main body 2 may be constructed using a lower shell where the lower shell main parts 3a, 3b are integrally linked by linking parts, not shown. Also, the opening shape of the opening for disc access is not limited to a rectangular shape whose longest sides are in a front-rear direction for the cartridge main body as in the example described above, and a rectangular opening shape whose longest sides are in a left-right direction for the cartridge main body or a rectangular opening shape whose longest sides are in a diagonal direction for a square cartridge main body may be used. Also, the disc cartridge according to the present invention is not limited to a cartridge for which recording and reproducing are possible using two optical heads simultaneously and also includes a disc cartridge constructed so as to include a cartridge main body with a lower shell (not shown) in which a disc access opening for recording and reproducing using a single optical head is formed.

What is claimed is:

1. A clamping plate comprising:
a circular-plate-shaped main plate;
and a cylindrical outer wall formed by bending an outer edge portion of the main plate,
wherein the clamping plate moves due to being pulled by magnetic attraction by a disc rotating mechanism to clamp a disk-shaped recording medium to the disc rotating mechanism, and
at least one of a convex that protrudes outward in a radial direction of the main plate and a concave that is depressed inward in the radial direction is formed in the outer wall.

2. A clamping plate according to claim 1,
wherein the outer wall is formed in a taper so that the diameter thereof increases as the distance from the main plate increases, and
the convex is formed so that a protruding end part thereof protrudes further outward than a largest diameter part of the outer wall.

3. A clamping plate comprising:
a circular-plate-shaped main plate; and
a cylindrical outer wall formed by bending an outer edge portion of the main plate,
wherein a circular concave that is depressed in a direction in which the outer wall is bent is formed in a central portion of the main plate and the clamping plate moves due to being pulled by magnetic attraction by a disc rotating mechanism to clamp a disk-shaped recording medium to the disc rotating mechanism,
wherein at least one of a concave that is depressed outward in a radial direction of the main plate and a convex that protrudes inward in the radial direction is formed in an inner wall of the circular concave.

4. A clamping plate according to claim 3,
wherein the inner wall is formed in a taper so that the diameter thereof decreases as the distance from the main plate increases, and
the convex is formed so that a protruding end part thereof protrudes further inward than a smallest diameter part of the inner wall.
